(19) United States
(12) Patent Application Publication
(10) Pub. No.: US 2008/0016777 A1
(43) Pub. Date: Jan. 24, 2008

(54) Emergency release

(75) Inventor: Michael Hormann, Halle/Westf. (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Marantec Antriebs-und Steuerungstechnik GmbH & Co. KG, Marienfeld (DE)

(21) Appl. No.: 11/879,601

(22) Filed: Jul. 17, 2007

(30) Foreign Application Priority Data
Jul. 20, 2006 (DE) 20 2006 011 218.9

(51) Int. Cl. E05B 65/10; E05F 15/00

(52) U.S. Cl. 49/280; 292/92

(57) ABSTRACT

The present disclosure relates to an emergency release for a garage door drive with a sliding latch, wherein the sliding latch is linearly movable by turning a rotary knob.

### CROSS REFERENCE TO RELATED APPLICATION

This application claims priority to German Utility Model Application No. 20 2006 011 218.9, filed Jul. 20, 2006, which is hereby incorporated by reference in it's entirety for all purposes

### FIELD

The present disclosure relates to an emergency release for a garage door drive.

### BACKGROUND AND SUMMARY

When a garage door drive is used for opening and closing a garage door, it must be ensured that the garage door still can be opened manually in the case of a failure of the garage door drive. For this purpose, an emergency release is usually provided, which separates the drive unit of the garage door drive from the garage door, as the same would otherwise provide a resistance to opening the garage door. Depending on the design of the garage door drive, such separation of the drive unit from the garage door is effected at different points of the garage door drive.

From DE 20 2004 020 003 U1 a garage door drive is known, whose drive motor is pivotally mounted, so that the drive unit can be separated from the door by swivelling back. From DE 203 02 525 U1, on the other hand, a spindle drive with linear movement is known, in which a release key is provided in a head portion, which via a release bar or a pull cable is connected with a release mechanism communicating with the motor transmission unit.

From DE 199 51 289 A1, a garage door drive for a swivelling door is known, in which there is provided a lever moving the door, which is connected with a tab movable along a rail. Said tab now is moved along the rail by a motor unit and thus opens and closes the garage door. As an emergency release, a pivoted lever now is provided here, which separates the connection between tab and garage door and thus provides for a manual movement of the garage door. The pivoted lever is moved via a pulling bell and a Bowden line. However, the known lever construction involves much effort and is difficult to handle. The use of a pulling bell in addition has the disadvantage that the same hangs down into the garage and thus can be actuated inadvertently, which would mean an unintended actuation of the emergency release.

Therefore, it is the object of the present disclosure to provide an emergency release, which has a simple design and can be operated safely.

In accordance with the present disclosure, this object is solved by an emergency release for a garage door drive comprises a sliding latch, which is linearly movable by turning a rotary knob. The linearly movable sliding latch for releasing the drive unit of the garage door drive from the door provides for a simply designed and nevertheless reliable emergency release, the actuation by the rotary knob representing a particularly user-friendly possibility for activating the emergency release. In particular, the use of a rotary knob involves the advantage that the emergency release no longer can be activated inadvertently.

Advantageously, the rotary knob includes a toothing and the sliding latch includes a toothed rack, which engage in each other. In this way, a safe and simple conversion of the rotary movement of the rotary knob into a linear movement of the sliding latch is ensured.

Advantageously, the sliding latch is prestressed in one direction. Usually, the sliding latch will be prestressed in such a direction that without actuation of the rotary knob, the drive unit of the garage door drive automatically is connected with the garage door and can move the garage door. Only in a case of emergency will the sliding latch be moved against said prestress by turning the rotary knob, such that the emergency release is actuated and the drive unit of the garage door drive is uncoupled from the garage door.

Furthermore advantageously, a Bowden line additionally engages the sliding latch of the present disclosure, which is linearly movable by actuating said Bowden line. This involves the advantage that the emergency release cannot only be activated by the rotary knob, which usually is directly mounted at the drive, but that in addition the Bowden line can be placed at a point accessible better, from which the emergency release likewise can be activated. Thus, while the one end of the Bowden line engages the sliding latch, the other end can for instance be guided to the outside of the garage, so that the emergency release can also be actuated from outside. The Bowden line then can be actuated for instance by opening a correspondingly designed lock.

Advantageously, the Bowden line engages the sliding latch such that the movement of the Bowden line is parallel to the direction of movement of the sliding latch. When the sliding latch is prestressed in one direction, the prestress advantageously acts against the pulling direction of the Bowden line.

Furthermore, it is advantageous when the sliding latch can independently be moved linearly by turning the rotary knob and by actuating the Bowden line. Thus, an actuation of the emergency release by the rotary knob or by the Bowden line is independently possible.

Furthermore advantageously, the toothing of the rotary knob is an external toothing and the sliding latch includes an oblong recess, on the one inner wall of which the toothed rack is disposed. Thus, the external toothing of the rotary knob can engage in the oblong recess in the sliding latch and engage the toothed rack disposed on the inner wall of the recess. This ensures a particularly simple and stable construction.

In a furthermore advantageous way, a spring is disposed in the oblong recess, which prestresses the sliding latch against the rotary knob. This ensures a particularly simple prestressing of the sliding latch in one direction. By turning the rotary knob, the sliding latch now can be moved linearly against the prestress of the spring.

Advantageously, the sliding latch consists of a latch element and an insert, which are connected with each other by a clip element, the toothed rack being disposed on the insert. This two-part construction allows a particularly easy manufacture of the sliding latch of the present disclosure.

It is of particular advantage when the Bowden line engages the latch element. For this purpose, the latch element advantageously includes the recess which typically is used for fastening Bowden lines, which recess comprises a groove along the shifting direction of the sliding latch for receiving the cable of the Bowden line and an enlarged terminal recess for receiving the head of the Bowden line.

### BRIEF DESCRIPTION OF THE FIGURES

One embodiment of the present disclosure will now be described in detail with reference to the drawing, in which:

FIG. 1 shows a perspective view of the embodiment of the emergency release in accordance with the present disclosure, and

FIG. 2 shows an exploded view of the embodiment of the emergency release in accordance with the present disclosure.

### DETAILED DESCRIPTION

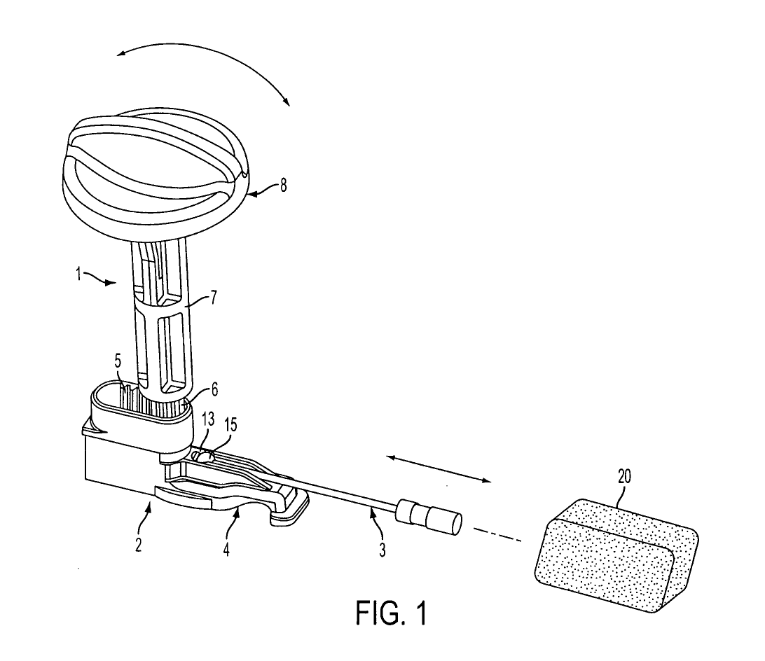

FIG. 1 shows the sliding latch 2 of the emergency release in accordance with the present disclosure, which is linearly movable by turning the rotary knob 1. The sliding latch 2 may be coupled in a garage door drive 20. The rotary knob 1 includes a handle 8, an axis of rotation 7 and a toothing 6. The toothing 6 is an external toothing at the lower end of the axis of rotation 7 and thus forms a pinion. The toothing 6 engages a toothed rack 5, which is disposed on the sliding latch 2. The sliding latch 2 includes a release bevel 4, which upon shifting the sliding latch 2 activates the emergency release mechanism. Furthermore, a Bowden line 3 is provided, which likewise engages the sliding latch 2. For this purpose, a groove for the cable of the Bowden line and a terminal recess 13 are provided on the upper surface of the sliding latch, in which recess the head 15 of the Bowden line engages and thus is connected with the sliding latch.

As is indicated by the arrows above the rotary knob 1 and the Bowden line 3, the sliding latch thus can be moved linearly by the rotary movement of the rotary knob 1 or via the linear movement of the Bowden line 3.

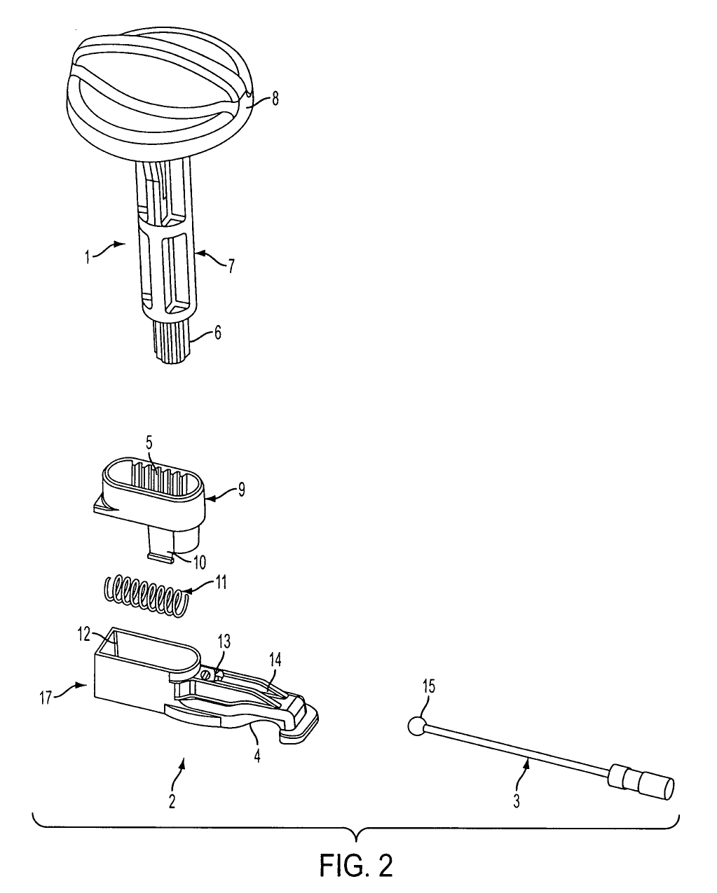

FIG. 2 shows an exploded view of the embodiment of the inventive emergency release as shown in FIG. 1. It can be seen that the sliding latch is composed of a latch element 17 and an insert 9. This latch element 17 includes an oblong recess 12, in which the insert 9 is inserted via clip elements 10. The insert 9 also includes a recess, on the inner surface of which the toothed rack 5 is disposed. The toothing 6 of the rotary knob 1, which forms a pinion, now extends into said recess and engages the inner toothing 5 of the insert. In addition, a spring 11 is provided, which is inserted in the recess 12 in the latch element 17 and thus prestresses the sliding element 2 against the rotary knob 1. With its axis of rotation 7, the rotary knob 1 is running in a non-illustrated housing, so that the sliding element 2 is also prestressed against this housing by the spring 11.

On its upper surface above the release bevel, the latch element 17 includes a groove 14, which extends along the direction of movement of the sliding latch and serves to accommodate the pull cable of the Bowden line 3. At one end, the recess 14 includes an enlarged terminal recess 13, in which engages the head 15 of the Bowden line 3, which is ball-shaped, so that the Bowden line 3 is connected with the latch element 15.

The spring 11 now prestresses the sliding latch 2 such that it is in the position shown in FIG. 1 without applying an external force via the rotary knob 1 or the Bowden line 3, in which position the sliding latch 2 is maximally moved to the left. By turning the rotary knob in clockwise direction or by pulling the Bowden line 3 to the right, the sliding latch 2 now can linearly be moved to the right, in order to activate the release mechanism.

1. An emergency release for a garage door drive with a sliding latch, wherein the sliding latch is linearly movable by turning a rotary knob.

2. The emergency release as claimed in claim 1, wherein the rotary knob includes a toothing and the sliding latch includes a toothed rack, which engage with each other.

3. The emergency release as claimed in claim 1, wherein the sliding latch is prestressed in one direction.

4. The emergency release as claimed in claim 1, wherein a Bowden line additionally engages the sliding latch, by whose actuation the sliding latch is linearly movable.

5. The emergency release as claimed in claim 4, wherein the sliding latch is configured to be independently moved linearly by turning the rotary knob and by actuating the Bowden line.

6. The emergency release as claimed in claim 2, wherein the toothing of the rotary knob is an external toothing and the sliding latch includes an oblong recess, on an inner wall of which the toothed rack is disposed.

7. The emergency release as claimed in claim 6, wherein a spring is disposed in the oblong recess, which prestresses the sliding latch against the rotary knob.

8. The emergency release as claimed in claim 2, wherein the sliding latch includes a latch element and an insert, which are connected with each other by a clip element, with the toothed rack being disposed on the insert.

9. The emergency release as claimed in claims 4, wherein the Bowden line engages the latch element, and where the sliding latch includes a latch element and an insert, which are connected with each other by a clip element, with the toothed rack being disposed on the insert.

10. The emergency release as claimed in claim 1, wherein the sliding latch is configured to activate the emergency release of the garage door drive.

11. A system comprising:
a garage door drive;
an emergency release coupled in the garage door drive with a sliding latch, wherein the sliding latch is linearly movable by turning a rotary knob, and where the rotary knob includes teeth and the sliding latch includes a toothed rack, where the rotary knob is positioned so that the teeth engage the toothed rack, where the sliding latch is configured to activate the emergency release so that the emergency release cannot be inadvertently activated.

12. The system as claimed in claim 11, wherein the sliding latch is prestressed in one direction.

13. The system as claimed in claim 12, further comprising a Bowden line that additionally engages the sliding latch, and by whose actuation the sliding latch is linearly movable.

14. The system as claimed in claim 13, wherein the sliding latch is configured to be independently moved linearly by turning the rotary knob and by actuating the Bowden line.

15. The system as claimed in claim 14, wherein the teeth of the rotary knob are positioned external to the knob, and the sliding latch includes an oblong recess on an inner wall of which the toothed rack is disposed.

16. The system as claimed in claim 15 further comprising a spring disposed in the oblong recess, which prestresses the sliding latch against the rotary knob.

17. The system as claimed in claim 11, wherein the sliding latch includes a latch element and an insert, which are connected with each other by a clip element, with the toothed rack being disposed on the insert.

18. The emergency release as claimed in claims 16, wherein the Bowden line engages the latch element.

19. An emergency release for a garage door drive, comprising:
a rotary knob
a sliding latch, wherein the sliding latch is linearly movable by turning the rotary knob, where the rotary knob includes teeth and the sliding latch includes a toothed rack, the knob and sliding latched configured and spaced relative to one another so that the teeth engage with the toothed rack and rotation of the knob actuates the sliding latch to activate the emergency release of the garage door drive.

20. The emergency release as claimed in claim 19, wherein the sliding latch is linearly movable, and where the sliding latch is configured to be independently moved linearly by turning the rotary knob.
